(19) United States
(12) Patent Application Publication
(10) Pub. No.: US 2023/0140734 A1
(43) Pub. Date: May 4, 2023

(54) TYPE OF BICYCLE CAPABLE OF IMPROVING DRIVING SAFETY

(71) Applicant: Changxian Xu, Quanzhou (CN)

(72) Inventor: Changxian Xu, Quanzhou (CN)

(21) Appl. No.: 17/536,129

(22) Filed: Nov. 29, 2021

(30) Foreign Application Priority Data
Nov. 1, 2021 (CN) 202111282016.2

(51) Int. Cl. B62J 6/015; B62J 3/12; B62J 6/045; B62J 29/00; B62J 6/055; B62J 1/06; B62J 6/028

(52) U.S. Cl. CPC B62J 6/015; B62J 3/12; B62J 6/045; B62J 29/00; B62J 6/055; B62J 1/06; B62J 6/028

(57) ABSTRACT

The invention discloses a new type of bicycle capable of improving driving safety, comprising a bicycle body, assemblies of rear view mirrors are symmetrically arranged on the handlebars of the bicycle body; a brake light is arranged on the rear end of the seat of the bicycle body, turn lights are symmetrically arranged on the fixed connecting rods which connect with the frame on both sides of the seat; an illuminating light is arranged on the vertical tube of handlebar of the bicycle body, an electric horn is arranged on the upper side of the illuminating light; the application scheme is complete, simple in structure, effective in improving driving safety, and is worthy of widespread promotion.

### TECHNICAL FIELD

The invention relates to the technical field of bicycles, in particular to a new type of bicycle capable of improving driving safety.

### BACKGROUND

Bicycle is a very important part of people's daily life, as a means of transportation, bicycle has been widely used in people's daily life, the use of bicycles can speed up people's movement, and bicycles are relatively light and cheap, and can achieve the function of physical exercise, many people choose bicycles as their means of transportation when they travel for a short distance, the structure and function of bicycles used daily are relatively simple, however, there are many defects in the process of people's daily use, for example, when it is necessary to turn, it is difficult for people to inform pedestrians on the road in advance, when turning, it is also difficult for people to see whether there are vehicles behind and pedestrians want to pass, when people use bicycles to travel in places without street lights at night, it is difficult to see the road conditions ahead clearly, when there are a lot of pedestrians or vehicles, it is difficult for people to tell others to make way for themselves. Therefore, a new type of bicycle capable of improving driving safety has become an urgent problem to be solved.

### SUMMARY OF THE INVENTION

The technical problem to be solved by the invention is a new type of bicycle capable of improving driving safety.

To solve the above technical problems, the invention provides the following technical scheme: a new type of bicycle capable of improving driving safety, comprising the bicycle body;

assemblies of rear view mirrors are symmetrically arranged on the handlebars of the bicycle body;

a brake light is arranged on the rear end of the seat of the bicycle body, turn lights are symmetrically arranged on the fixed connecting rods which connect with the frame on both sides of the seat;

an illuminating light is arranged on the vertical tube of handlebar of the bicycle body, an electric horn is arranged on the upper side of the illuminating light;

the seat tube of the bicycle body is provided with a fixing plate toward the side wall of the rear wheel, the fixing plate is provided with a battery, the battery is electrically connected with the brake light, turn lights, illuminating light and electric horn respectively.

As an improvement, a shock absorbing spring is arranged on the seat pillar of the bicycle body.

As an improvement, the seat of the bicycle body is made of silica gel.

As an improvement, the battery is a portable battery and lithium battery.

Compared with the prior art, the invention has the following advantages: the turn lights and brake light are arranged on the seat of the bicycle body to remind pedestrians and vehicles on the road when turning; the left and right rear view mirrors are arranged on the handlebars to check whether there are pedestrians or vehicles trying to pass through when turning; the illuminating light and electric horn are arranged on the vertical tube of handlebar to illuminate when riding a bicycle at night and remind pedestrians and vehicles ahead of the road when there is a traffic jam; the application scheme is complete, simple in structure, effective in improving driving safety, and is worthy of widespread promotion.

### BRIEF DESCRIPTION OF THE DRAWINGS

FIG. 1 is a schematic diagram1 of the new type of bicycle capable of improving driving safety.

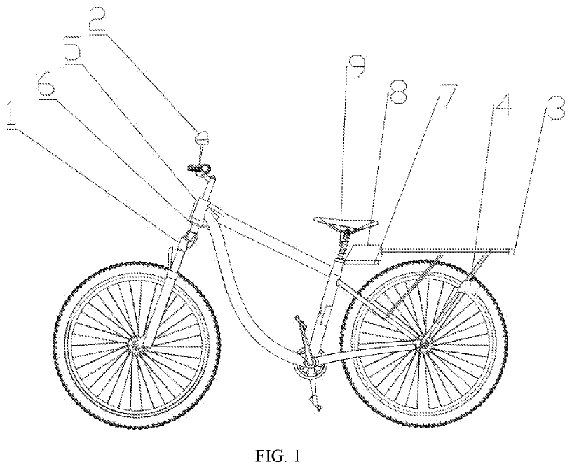

FIG. 2 is a schematic diagram2 of the new type of bicycle capable of improving driving safety.

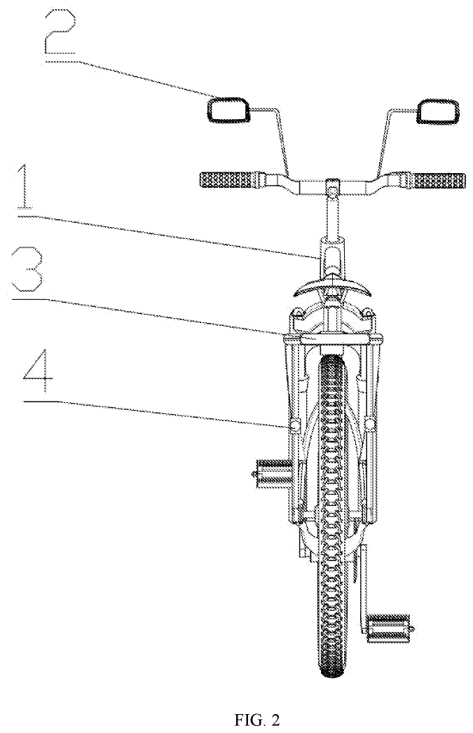

FIG. 3 is a schematic diagram3 of the new type of bicycle capable of improving driving safety.

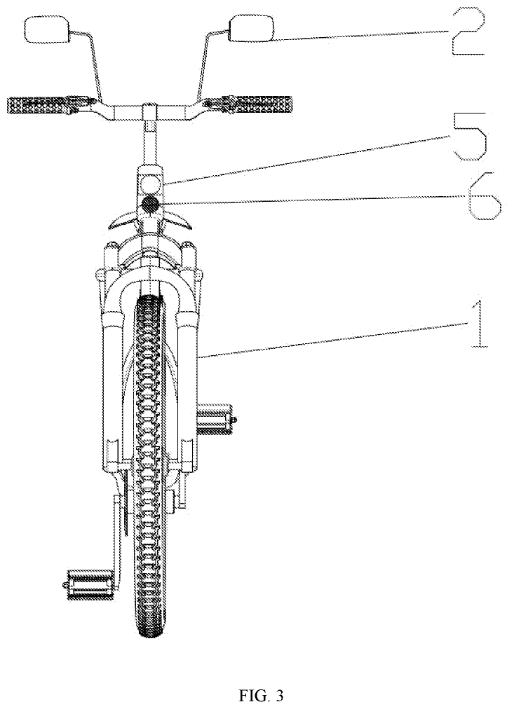

As shown in the figure: 1 refers to the bicycle body, 2 refers to assemblies of rear view mirrors, 3 refers to the brake light, 4 refers to turn lights, 5 refers to the illuminating light, 6 refers to the electric horn, 7 refers to the fixing plate, 8 refers to the battery, 9 refers to the shock absorbing spring.

### DESCRIPTION OF EMBODIMENTS

The new type of bicycle capable of improving driving safety of the invention is further explained below in combination with the drawing.

Combined with the drawings 1-3, a new type of bicycle capable of improving driving safety, comprising the bicycle body 1;

assemblies of rear view mirrors 2 are symmetrically arranged on the handlebars of the bicycle body 1;

a brake light 3 is arranged on the rear end of the seat of the bicycle body, turn lights 4 are symmetrically arranged on the fixed connecting rods which connect with the frame on both sides of the seat;

an illuminating light 5 is arranged on the vertical tube of handlebar of the bicycle body, an electric horn 6 is arranged on the upper side of the illuminating light 5;

the seat tube of the bicycle body is provided with the fixing plate 7 toward the side wall of the rear wheel, the fixing plate 7 is provided with a battery 8, the battery 8 is electrically connected with the brake light 3, turn lights 4, illuminating light 5 and electric horn 6 respectively.

The shock absorbing spring 9 is arranged on the seat pillar of the bicycle body 1.

The seat of the bicycle body 1 is made of silica gel.

The battery 8 is a portable battery and lithium battery 8.

The process of the specific embodiment of the new type of bicycle capable of improving driving safety of the utility model is as follows:

the turn lights 4 and brake light 3 are arranged on the seat of the bicycle body 1, so that it is convenient for people to remind pedestrians and vehicles on the road in advance when riding the bicycle to turn and brake; the left and right rear view mirrors are arranged on the handlebars, so that it is convenient for people to check whether there are pedestrians or vehicles trying to pass through when turning; the illuminating light 5 and electric horn 6 are arranged on the vertical tube of handlebar, so that it is convenient for people to illuminate their bicycles when riding at night and remind pedestrians and vehicles ahead of the road to move out of the way when there is a traffic jam; the faucet of bicycle body 1 can be properly raised to effectively protect the back and cervical vertebra; the seat is made of thickened silicone, shock absorbing spring 9 of the seat pillar can effectively protect the rider's buttocks from the rugged road conditions, so as to avoid buttocks injury.

The invention and its embodiments are described above, and this description is not restrictive, what is shown in the drawings is only one of the embodiments of the invention, and the actual structure is not limited to this. In a word, if those having ordinary skills in the art are inspired by it, without departing from the creative purpose of the invention, designing structural methods and embodiments similar to the technical scheme without creativity, they should fall within the protection scope of the invention.

1. A new type of bicycle capable of improving driving safety, comprising a bicycle body (1), wherein:
assemblies of rear view mirrors (2) are symmetrically arranged on the handlebars of the bicycle body (1);
a brake light (3) is arranged on the rear end of the seat of the bicycle body (1), turn lights (4) are symmetrically arranged on the fixed connecting rods which connect with the frame on both sides of the seat;
an illuminating light (5) is arranged on the vertical tube of handlebar of the bicycle body (1), an electric horn (6) is arranged on the upper side of the illuminating light (5);
the seat tube of the bicycle body (1) is provided with a fixing plate (7) toward the side wall of the rear wheel, the fixing plate (7) is provided with a battery (8), the battery (8) is electrically connected with the brake light (3), turn lights (4), illuminating light (5) and electric horn (6) respectively.

2. A new type of bicycle capable of improving driving safety according to claim 1, wherein a shock absorbing spring (9) is arranged on the seat pillar of the bicycle body (1).

3. A new type of bicycle capable of improving driving safety according to claim 1, wherein the seat of the bicycle body (1) is made of silica gel.

4. A new type of bicycle capable of improving driving safety according to claim 1, wherein the battery (8) is a portable battery and lithium battery (8).
